(19) United States
(12) Patent Application Publication
(10) Pub. No.: US 2013/0201013 A1
(43) Pub. Date: Aug. 8, 2013

(54) Systems and Methods for Notifying a Caregiver of the Condition of a Child in a Vehicular Child Safety Restraint

(71) Applicant: Cars-N-Kids LLC, St. Louis, MO (US)

(72) Inventor: Gregory B. Schoenberg, St. Louis, MO (US)

(73) Assignee: CARS-N-KIDS LLC, St. Louis, MO (US)

(21) Appl. No.: 13/835,498

(22) Filed: Mar. 15, 2013

Related U.S. Application Data
(63) Continuation-in-part of application No. 13/648,949, filed on Oct. 10, 2012.
Application No. 13/648,949 is a continuation-in-part of application No. 13/370,021, filed on Feb. 9, 2012.
Application No. 13/370,021 is a continuation-in-part of application No. 12/335,421, filed on Dec. 15, 2008, now Pat. No. 8,212,665.
(60) Provisional application No. 61/545,354, filed on Oct. 10, 2011.
(60) Provisional application No. 61/678,508, filed on Aug. 1, 2012.
(60) Provisional application No. 61/441,199, filed on Feb. 9, 2011.
(60) Provisional application No. 61/538,647, filed on Sep. 23, 2011.
(60) Provisional application No. 61/013,929, filed on Dec. 14, 2007.
(60) Provisional application No. 61/504,113, filed on Jul. 1, 2011.

(51) Int. Cl. B60Q 1/00

(52) U.S. Cl. CPC B60Q 1/00
USPC 340/438

(57) ABSTRACT

Child seat installation monitoring system and methods that monitor child seat orientation, belt tension, air temperature, and other factors, and provide notifications and alerts to a user of conditions via indications, a mobile device such as a smart phone, an in-car notification system, and other systems.

### CROSS REFERENCE TO RELATED APPLICATION(S)

This application is a Continuation-in-Part (CIP) of U.S. Utility application Ser. No. 13/648,949, filed Oct. 10, 2012, which claims benefit of U.S. Provisional Patent Application 61/545,354, filed Oct. 10, 2011, and U.S. Provisional Patent Application 61/678,508, filed Aug. 1, 2012, and which is a Continuation-in-Part (CIP) of United States Utility patent application Ser. No. 13/370,021, filed Feb. 2, 2012, which, in turn, claims the benefit of U.S. Provisional Application Ser. No. 61/441,199, filed Feb. 9, 2011, U.S. Provisional Application Ser. No. 61/504,113, filed Jul. 1, 2011, and U.S. Provisional Application Ser. No. 61/538,647, filed Sep. 23, 2011, and which is a Continuation-in-Part (CIP) of United States Utility patent application Ser. No. 12/335,421, now U.S. Pat. No. 8,212,665, which, in turn, claims the benefit of U.S. Provisional Application Ser. No. 61/013,929, filed Dec. 14, 2007. The application also claims the benefit of U.S. Provisional Patent Application 61/678,508, filed Aug. 1, 2012. The entire disclosure of all of these documents is herein incorporated by reference.

### BACKGROUND

1. Field of the Invention

This disclosure is related to the field of child safety restraints. Specifically, to restraints which can detect the orientation and report various conditions relating to the status of the child and restraint in a vehicle.

2. Description of the Related Art

Caregivers of children often must travel with those children in a vehicle. Because the safety belts preinstalled in most vehicles are sized for use with an adult, those safety belts are generally unsuitable and dangerous for use with children. To remedy this, infant, toddlers, and young children use specially designed safety restraints in the form of a “car seat” or “child seat,” a separate chair placed in the car on top of the vehicular seat and attached to the vehicle, generally using either specially designed connectors for that purpose, such as the LATCH system, or the vehicle's preinstalled safety belts.

However, the majority of vehicular child safety restraint seats, popularly called “child seats,” are not properly installed, and an improperly installed seat exposes the child to increased risk of injury. Although child seat manufacturers and automobile companies provide detailed instructions on how to install child seats in vehicles, users routinely install the child seats at improper angles, with incorrect tension on the restraining belts between the seat and the vehicle, and/or with incorrect tension on the restraining belts between the seat and the child.

Some seats include a mechanical level (such as a ball or bubble level) to aid the user in installing the seat at the proper angle, but bubble levels work on just one plane of orientation and these levels orient along only one dimension, typically pitch—the forward-to-back orientation of the seat, and the proper installation of a child seat can require that multiple planes or orientation be adjusted. For example, the side-to-side angle of the child seat (“roll”) and the rotational orientation (“slip”) also should be properly set. Bubble levels also cannot provide feedback on belt tension. Further, even where a child seat initially is installed properly the child seat may be jostled or shifted and tension may loosen over time.

Further, as the child uses the seat, the belt tension and orientation will change over time and needs to be corrected. Further, the proper tension and orientation may also change as the child grows and ages. Busy caregivers rarely stop to check seat installation, and thus a seat that was properly installed in the first instance will, over time, become improperly installed.

Further, children, particularly infants, have basic needs that the caregiver must supply, such as proper temperature, dryness and cleanliness. When the vehicle is in motion, the caregiver should not divert attention from operating the vehicle to check these conditions, as doing so poses a danger of a vehicular accident. Further, certain conditions simply cannot be checked from the driver's chair, such as the temperature in the back of a minivan, or where a toddler being potty-trained has wet herself.

Further, there are certain dangerous conditions which require multiple layers of alerting in case the primary caregiver does not respond. For example, where an infant is left in the vehicle multiple individuals should be notified to maximize the chances of a rapid response to rescue the child.

Ordinary use of a family vehicle tends to dislodge the child seat from proper orientation and tension over time. The insertion and removal of cargo in the vehicle may bump the child seat, the child using the seat may move, or passengers in the vehicle may climb over and around the seat or use it for leverage in entering, existing, or moving about in the vehicle. In the fast-paced life of a modern family, users may not have time to assess the problem, to say nothing of correcting it, again placing the children at increased risk of injury. The existing bubble levels provide no means for notifying the user that the child seat orientation is unsafely out of alignment, or that the belt tension is too loose.

Further, in the fast-paced life of a family, children may be hastily buckled into their child seats, and the buckles may not latch properly. Also, older children often learn how to undo the safety restraints in the child seat, and may clandestinely unclasp or unbuckle themselves without the vehicle operator or passengers noticing. This again poses increased risk to the child.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things is a child seat alert system providing notifications of various conditions of the child or child seat to a caregiver, including a multi-layer cascading alert hierarchy to improve the chances of a timely response to a dangerous condition. The alert includes, among other things, the use of monitors within or near a child seat, which communicate with a mobile phone, vehicular telematics system, or other device notifications relating to the detected condition.

Described herein, among other things, is a system for providing notifications of a condition relating to a child in vehicular child seat, the system comprising: a sensor installable in a vehicular child seat and capable of detecting a condition relating to a child in the vehicular child seat when the sensor is installed in the vehicular child seat; a transmitter connected to the sensor by circuitry; computer-readable instructions on a memory comprising programming which, when the memory is in a device capable of receiving data from the transmitter, causes the mobile device to transform into a notification data received by the mobile device from the transmitter relating to a condition detected by the sensor when the sensor is installed in a vehicular child seat.

Also described herein is an embodiment in which the sensor is a three-axis accelerometer and the condition is the orientation of the vehicular child seat installed in a vehicle.

Also described herein is an embodiment in which the sensor is a force transducer and the condition is the tension on a safety restraint belt.

Also described herein is an embodiment in which the sensor is a temperature sensor and the condition is the air temperature near a child in the vehicular child seat.

Also described herein is an embodiment in which the notification is a graphical element caused to be displayed by the device.

Also described herein is an embodiment in which the notification is an audible tone caused to be emitted by the device.

Also described herein is an embodiment in which the notification is a message transmitted by the device to another device

Also described herein is an embodiment in which the message is a user-defined text message sent to a user-defined mobile telephone number.

Also described herein is an embodiment in which the message is a user-defined e-mail message sent to a user-defined e-mail address.

Also described herein is an embodiment in which the e-mail address is a distribution list.

Also described herein is an embodiment in which the message is a call.

Also described herein is an embodiment in which the message is sent to an emergency response call center.

Also described herein is an embodiment in which the message is transmitted only after a condition first detected by the sensor is again detected by the sensor after a user-defined amount of time elapses from the first detection.

Also described herein is an embodiment in which the device is a mobile device.

Also described herein is an embodiment in which the notification is the vibration of the mobile device.

Also described herein is an embodiment in which the mobile device is a mobile phone.

Also described herein is an embodiment in which the mobile phone is selected from the group consisting of an iPhone, a Windows Phone, a Galaxy phone, a Google phone, an Android phone.

Also described herein is an embodiment in which the mobile device is a tablet computer.

Also described herein is an embodiment in which the device is a vehicular telematics system.

Also described herein is an embodiment in which the transmitter communicates using the Bluetooth protocol.

### BRIEF DESCRIPTION OF THE DRAWINGS

FIG. 1 shows an embodiment of a child seat orientation monitor in a child seat.

FIG. 2 shows an exploded view of an embodiment of a child seat orientation monitor.

FIGS. 3 through 7 show embodiments of screenshots which can be presented to a user on a device, such as a smart phone, which provide indications of features and show alterations to the child seat orientation.

FIGS. 8, 8A, 8B, 8C, 8D, 8E, 8F, and 9 show circuit diagrams of embodiments of a child seat orientation monitor.

FIG. 10 depicts a schematic diagram of an embodiment of the systems and methods.

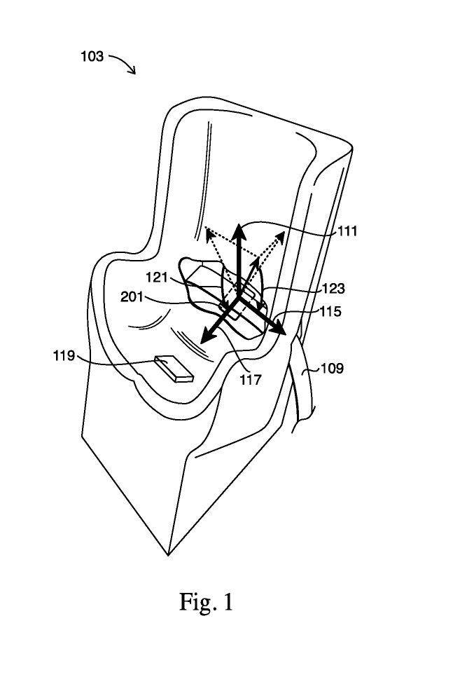

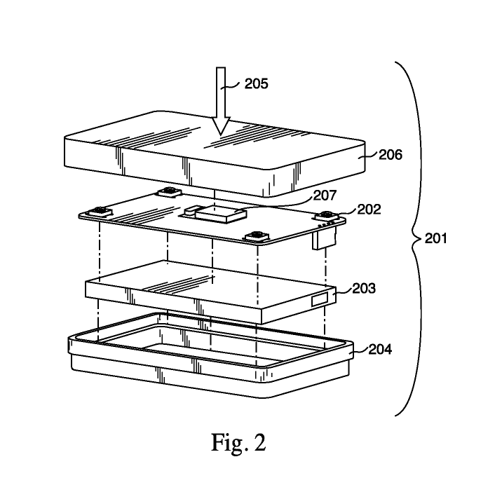

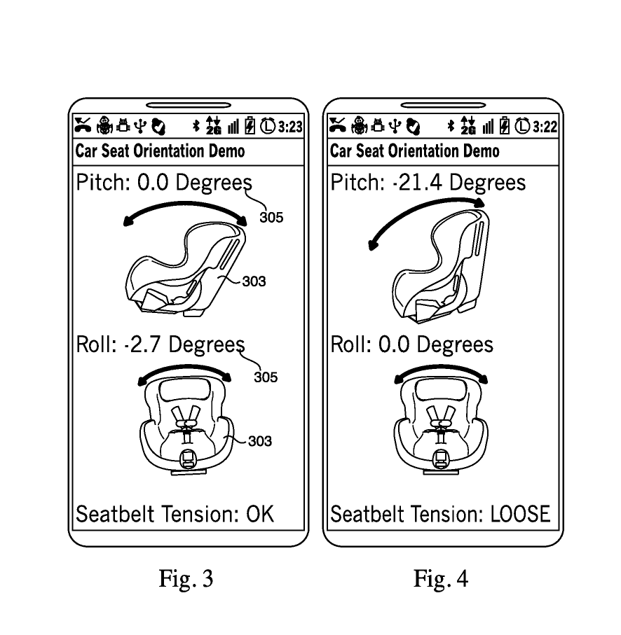

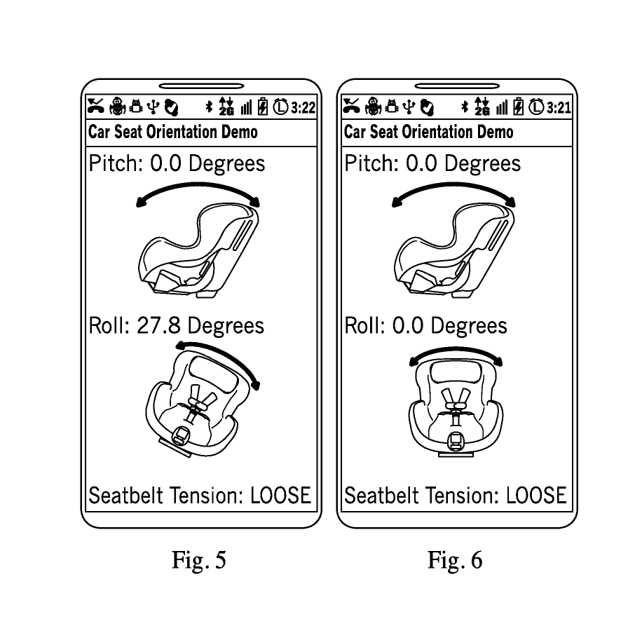

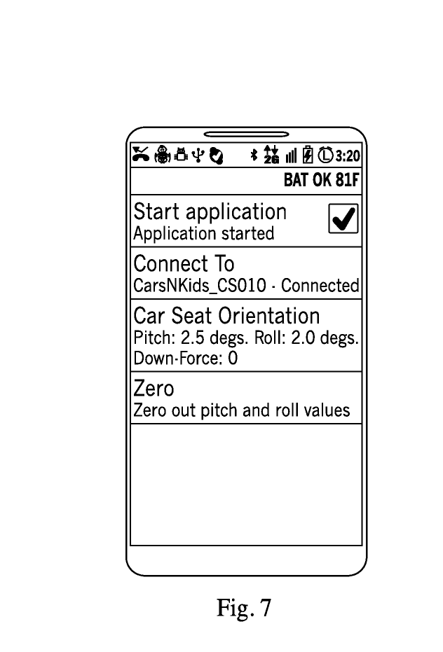

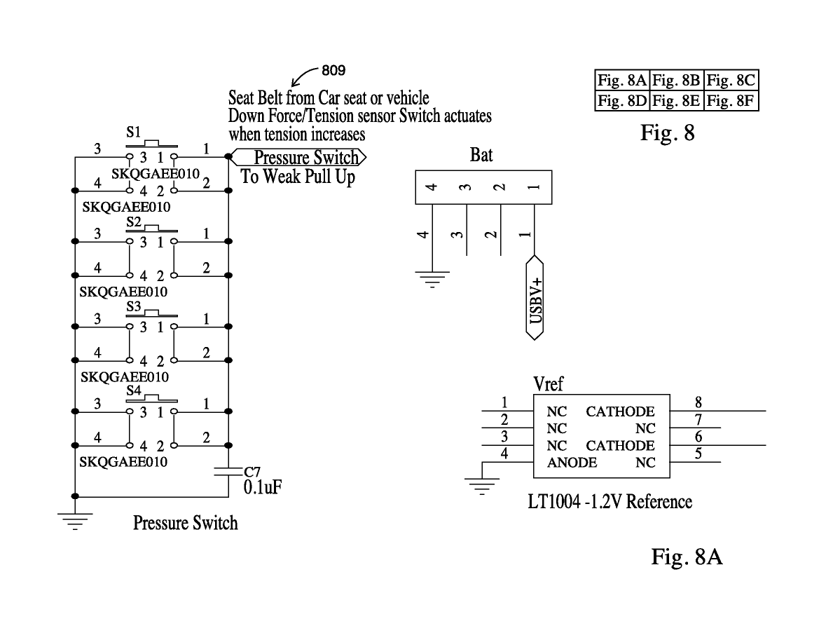

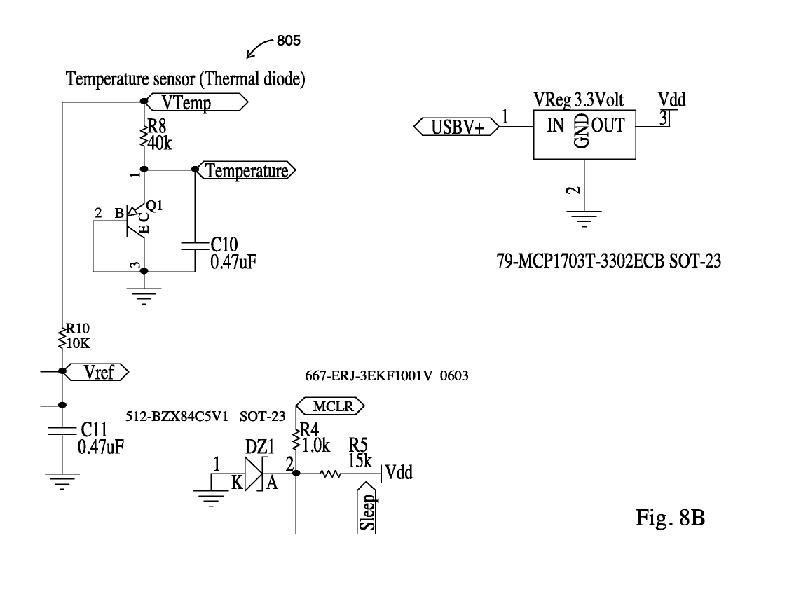

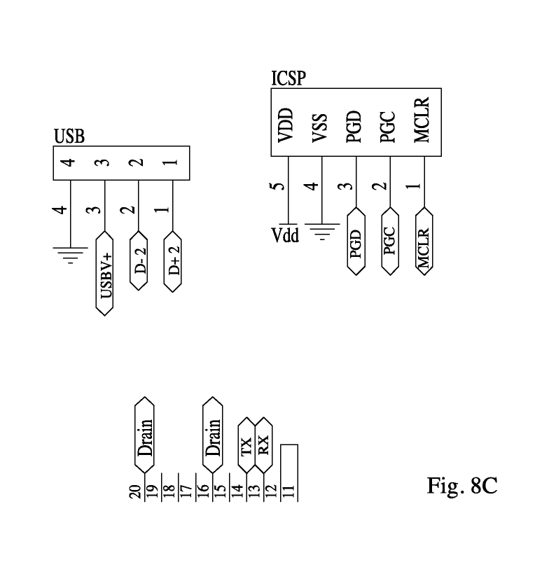

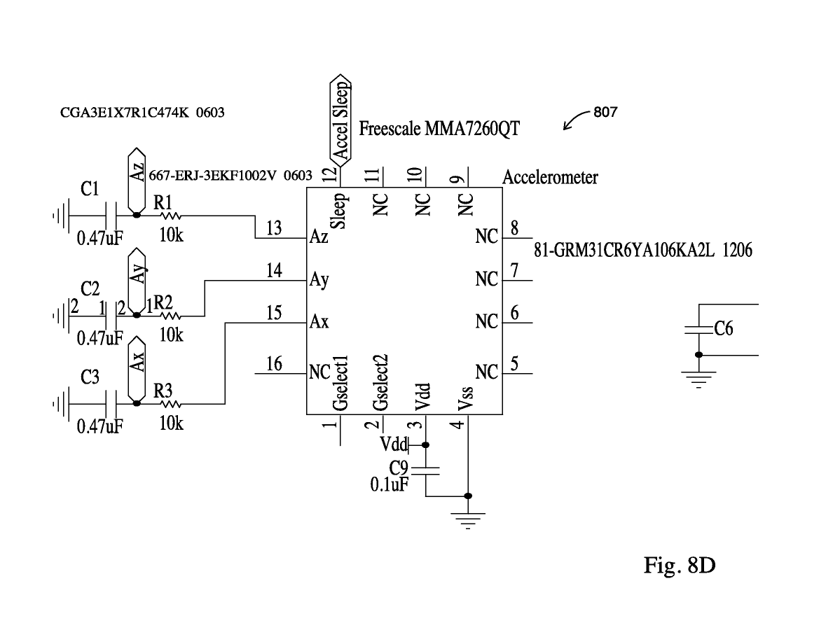

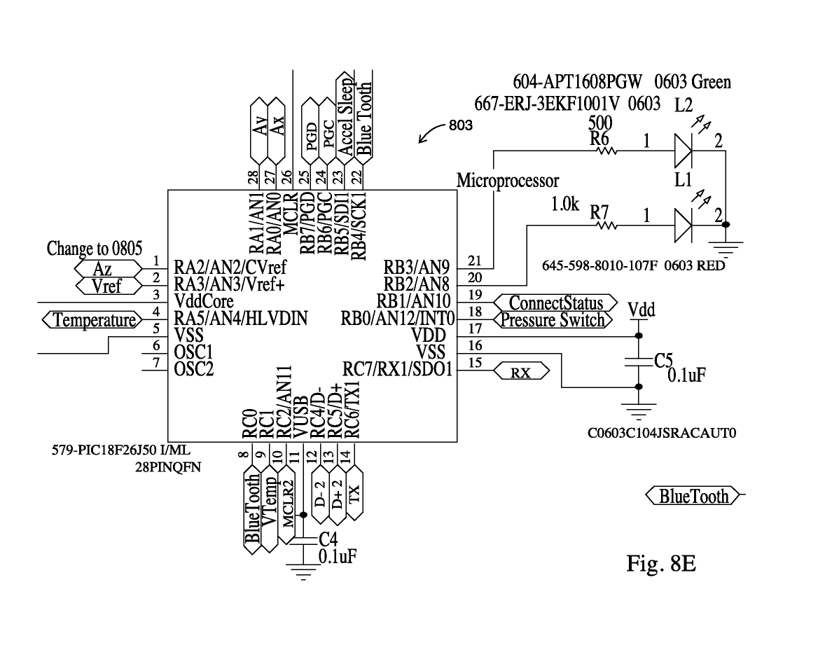

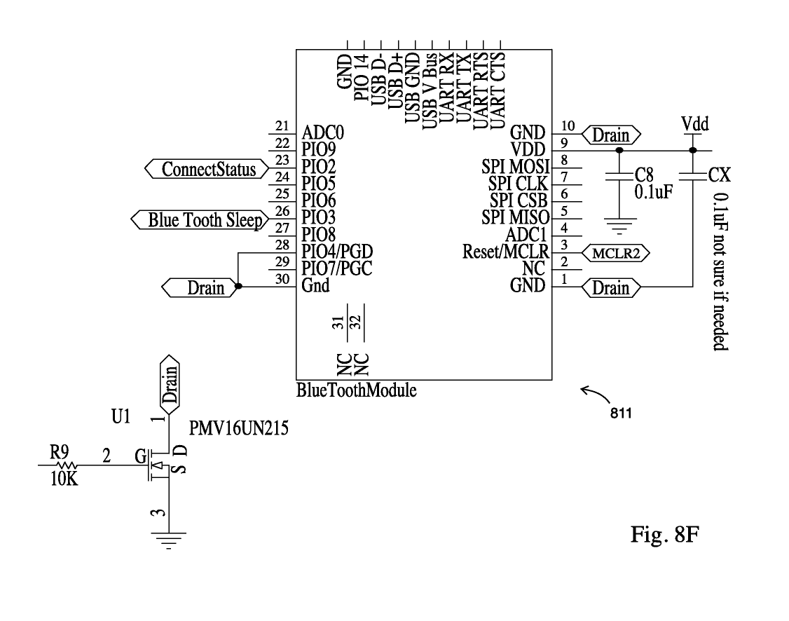

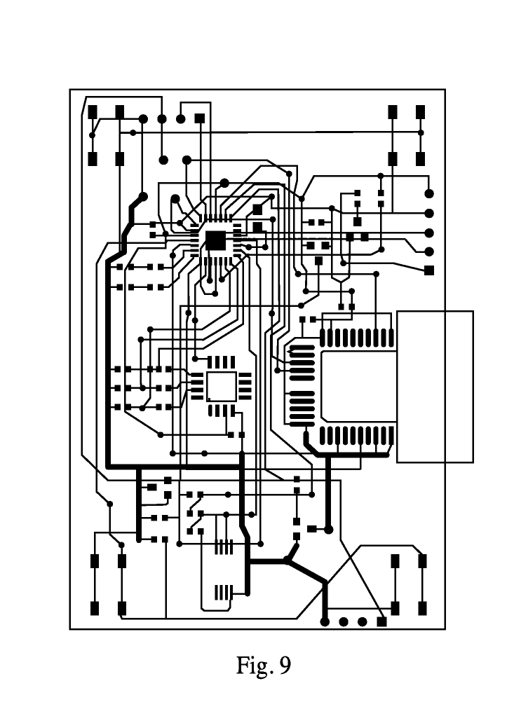

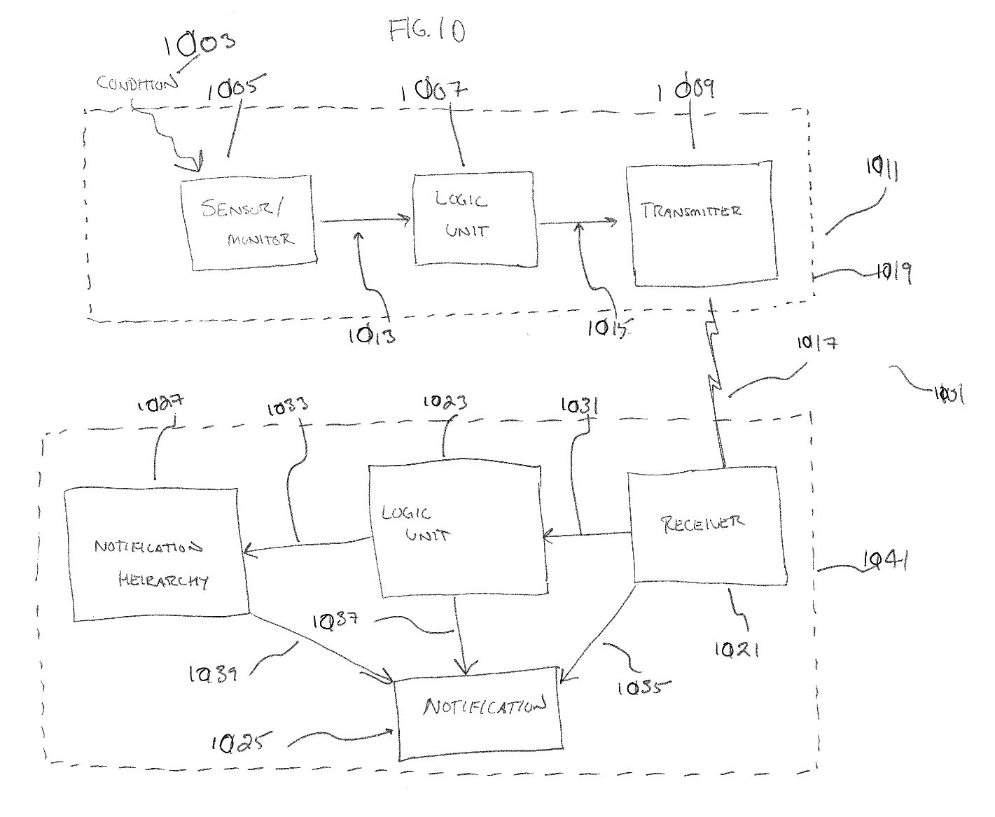

### DESCRIPTION OF PREFERRED EMBODIMENT

Although the present invention is described with particular reference to the accompanying drawings, it is to be understood at the outset that it is contemplated that the present invention may vary in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

Generally, the systems and methods described herein include four primary component systems, and may also comprise further systems. The four primary component systems are: a monitoring system comprising one or more sensors; a transmitting system; a receiving system; and a notification system. Generally, the systems and methods detect a condition relating to the health or safety of a child in a vehicular child seat, transmit information related to the detected condition to a receiver, and report the condition to a caregiver, user, or other appropriate personnel.

In the preferred embodiment, the monitoring and transmitting systems are generally implemented in a single device, generally referred to herein as a monitor or monitoring device. Also in the preferred embodiment, the receiving system and notification system are generally implemented in a single device. These systems are generally described with reference to a mobile device, such as a Smartphone, but it is specifically contemplated that this device could be a computerized vehicular information system such as vehicular telematics.

FIG. 10 provides a logic diagram of an embodiment of these and other component systems and a manner in which they may interact. This diagram should not be understood as limiting, but rather as an example of how the systems and methods might be implemented in an embodiment (1001). In the depicted embodiment (1001) of FIG. 10, a condition (1003) related to the health or safety of a child in a child seat is detected by a sensing system (1005). The sensing system (1005) converts the detected condition into data via electronic circuitry and transfers (1013) that data to a logic unit (1007), such as a microprocessor. The logic unit (1007) processes the data received and transfers (1015) the processed data to a transmitter (1009). Generally, the logic unit (1007) prepares or packages the data into a particular format, performs error checking or correction, and performs any other function known in the art to be performed by logic units (1007) such as microprocessors. As will be understood, these component systems and functions would be integrated into a monitor (1011) placed in a child seat or are integrated into the child seat itself. Data transfers (1013) and (1015) are generally achieved through the use of further electronic circuitry, such as a system bus or local bus connecting components (1005), (1007) and (1009) to an integrated circuit board, but may alternatively be a wired or wireless connection in an embodiment.

The transmitter (1009) transmits (1017) data concerning the detected condition (1003) to a receiver (1021). Transmittal (1017) is generally performed by using a wireless protocol, including, but not limited to, short-range protocols such as Bluetooth® and IEEE 802.11, as well as long-range protocols such as 3G, 4G, LTE, and other wireless telephone, data, and radio protocols. The receiver (1021) transfers (1031) and (1035) the received data to other component(s) (1023) and (1025). The components (1023) and (1025) may be a system (1025) for notifying a user of the condition, but is generally a second logic unit (1023) which performs further data processing and logic functions. Among other things, the second logic unit (1023) may be a microprocessor, such as a mobile device CPU. The second logic unit (1023) may filter the data according to user preferences and/or configuration settings, or may reformat, repackage, alter, store, or perform any other function known in the art to be performed by logic units (1007). The logic unit (1007) generally then transfers (1037) data relating to the detected condition (1003) to the notification system (1025), or otherwise causes data relating to the condition to be conveyed to a user via a notification system (1025).

In the embodiment of FIG. 10, the receiving system (1021), second logic unit (1023), and notification system (1025) are integrated into a device (1041), generally a mobile phone or vehicular telematics system. Data transfers (1031), (1033), (1035), and (1039) are generally achieved through the use of further electronic circuitry, such as a system bus or local bus connecting components (1021), (1023), (1025), and (1027) to an integrated circuit board, but may alternatively be a wired or wireless connection in an embodiment.

These and other components are described in more detail elsewhere herein. Such other components include, but are not limited to, systems and methods for operating a vehicular automation system in response to a condition.

Sensing and Monitoring Systems

Generally, a monitor (1011) is an enclosed device including one or more sensors, a transmitter, a microprocessor, and circuitry interconnecting these items for data exchange. The sensors are generally electronic devices capable of detecting conditions relevant to the health or safety of a child in a vehicular child seat. The sensors generally convert detected conditions into data, which in turn may be conveyed by electric to other components of the monitor (1011), primarily a microprocessor.

Among other things, a sensor may sense or detect conditions including, but not limited to, internal vehicle temperature; internal vehicle humidity; external temperature; external humidity; internal vehicle air pressure; external air pressure; presence or concentration of certain gases in the vehicle, including but not limited to, gases which may pose health risks, such as carbon monoxide and carbon dioxide; presence or level of moisture or wetness, particularly in the form of liquid; presence or level of sound or noise level within the vehicle, including, but not limited to, the decibel level of such sound or noise; presence or level of particular types of sound or noise, including, but not limited to, a human cry; motion within the vehicle; motion outside the vehicle; vehicle itself in motion, including, but not limited to, direction, velocity, and duration of motion; motion of a child in a child seat, including, but not limited to, rhythmic motion indicative of breathing or sleeping; presence of a child in a child seat; orientation of a child seat in the vehicle; presence or intensity of light in the vehicle; presence or intensity of air movement in the vehicle; tension on a belt holding a child seat to a vehicle; tension on a safety restraint harness holding a child to a child seat; pressure or weight of a child in a child seat; or presence or level of light or brightness near a child seat. Some of these conditions are described in further detail herein.

It is specifically contemplated that a sensor may be a component internal to a monitor but it is also specifically contemplated that a sensor may be a component generally external to a monitor and connected thereto by wire or through a wireless communications protocol. In the latter case, the sensor itself may also include a transmitter system, and the monitor may also contain a receiver system to receive transmissions from a remote sensor. In an alternative embodiment, where a remote sensor has a transmitter system, it may transmit data directly to a receiving system as described elsewhere herein. However, it is generally preferred that data concerning conditions detected by the sensors are processed through a central logic unit, such as a microprocessor, in the monitor.

This has several advantages and simplifies the systems significantly. First, the receiving system (e.g., a mobile phone) need only synchronize with one transmitting system and need only be capable of interfacing using the communications protocol of that transmitting system, reducing the number of communications connections and devices the user must manage. Second, this arrangement simplifies the development of software applications as described herein, and improves the ergonomic complexity and user-friendliness of these applications. Particularly in an emergency, it is desirable that the systems and methods be simple and intuitive so that a user, who may be flustered or panicked, can effectively use the systems and methods.

The monitor may include a sensor such as the child seat orientation monitoring system contemplated by U.S. Utility application Ser. No. 13/648,949, filed Oct. 10, 2012, the entirety of which is incorporated herein by reference.

The monitor may include a sensor such as the temperature sensor contemplated by U.S. Utility application Ser. No. 13/648,949, filed Oct. 10, 2012, the entirety of which is incorporated herein by reference.

The monitor may include a sensor such as the light sensor contemplated by U.S. Utility application Ser. No. 13/648,949, filed Oct. 10, 2012.

The monitor may include a sensor such as the breathing sensor contemplated by U.S. Utility application Ser. No. 13/648,949, filed Oct. 10, 2012.

The monitor may include a sensor such as the pressure sensor contemplated by U.S. patent application Ser. Nos. 12/335,421, filed Dec. 15, 2008; 61/013,929 filed Dec. 14, 2007; 61/441,199, filed Feb. 9, 2011; 61/504,113, filed Jul. 1, 2011; and 61/538,647, filed Sep. 23, 2011. The entire disclosures of all such documents are incorporated herein by reference.

The monitor may include a sensor such as the belt tension sensor contemplated by U.S. Utility application Ser. No. 13/648,949, filed Oct. 10, 2012.

The monitor may include a sensor such as the sensor detecting the tension of the safety restraint harness restraining a child in a child seat contemplated by U.S. Utility application Ser. No. 13/648,949, filed Oct. 10, 2012.

Notification Systems

The systems and methods described herein generally include a notification system. Generally, the notification system comprises a mobile device having a microprocessor, a display, and an audio system. It is also generally contemplated that the mobile device further includes the receiver. Although the notification system is generally described in reference to a mobile device application, it is specifically contemplated that the notification system may be a vehicular telematics system. In such an embodiment, the vehicular telematics system generally comprises a microprocessor, a display, and a vehicular audio system.

Generally, the receiver receives wireless communication from a monitor transmitting information regarding conditions detected by sensors as described elsewhere herein. The notification system conveys this information to the user. Generally, it is contemplated that the notification system conveys this information to the user via an application on the mobile device programmed to display a user interface including at least some of the information received on the display. The particular information displayed, and the format and appearance of same, is generally user-configurable. The notification system may also have a user-configurable escalation hierarchy wherein when an urgent or emergent notification is not timely acknowledged, the mobile device attempts an alternative form of notification as defined by the escalation hierarchy. It is also specifically contemplated, as described elsewhere herein, that an application may run on such the mobile device, including receiving, processing, and conveying information related to conditions detected by the sensors to the user on the display.

In an embodiment, a user installs on the user's mobile device an application programmed for interoperation with a monitor. The user generally installs the monitor in a vehicular child seat and installs the vehicular child seat in a vehicle. The user then synchronizes the monitor with the application, sometimes known in the art as “pairing” devices. This pairing establishes a wireless communications channel between the transmitter in the monitor and the receiver in the mobile device.

In an embodiment, the application scans for child seat monitors which may be paired, such as by using self-discovering protocols and devices. In the preferred embodiment, the mobile device and monitor communicate using the Bluetooth® protocol, but other protocols may be used in an embodiment, including but not limited to IEEE 802.11, 3G, 4G, LTE, and other wireless communication protocols now known or in the future developed in the art.

Generally, the application displays an identifier uniquely identifying each detected monitoring device. This identifier assists the user in determining which monitor(s) the user wishes to pair with the mobile phone. In an embodiment, the user may change the unique identifier displayed for a monitor, such as to provide a user-friendly manner for identifying the particular child seat. For example, the default identifier may be a serial number which is meaningless to the user and hard to remember. However, the user may assign a user-defined custom identifier to the monitor in the mobile device application, such as a plain language identifier which identifies the vehicle and child seat (e.g., “Lauren's Explorer Seat”). This is particularly helpful for families with multiple children in child seats, such as families with twins or multiple young children, and families with multiple vehicles having child seats. It should be noted that this identifier does not necessarily alter any identifiers inherent to the monitor itself. That is, a user-defined identifier assigned to a given monitor by a user does not also change the identification of that monitor when detected by a different mobile device. By implementing this functionality at the application level, a monitor may have a plurality of user-defined identifiers, each such identifier distinct to a particular user.

The application may provide an interface indicating the child seat(s) is being actively monitored by the application. As the application may not actively monitor all seats with which the mobile device has been paired, the application may provide an interface indicating the child seat detected but not being monitored by the application. The application may allow the user to select which detected child seat will be actively monitored. By way of example, and not limitation, where the user has multiple child seats in her vehicle but is traveling with only one child occupying a child seat, the user may temporarily disable alerts for the unoccupied seats to avoid receiving superfluous notifications related to those seats. This may be done on a schedule. For example, the application may provide to the user a user interface resembling a calendar, and the user may select periods of time during which the application will actively monitor a given monitor or set of monitors.

By way of example and not limitation, this is particularly useful where two parents operating two different vehicles with two different car seats alternate dropping off and picking up a child from a day care or school. The parent not dropping off the child does not need to receive superfluous notifications from the monitor in that parent's car because there is no child in the car seat in the morning. That parent may configure the application using the user interface not to actively monitor the child seat until 5:00 pm, when that parent picks up the child from day care.

As described above, generally a sensor in a monitor detects a condition in the vehicle and reports the condition to the mobile device by transmitting data related to the condition using the transmitter. The mobile device then conveys this information to the user, generally on the device's display, also as described herein. The mobile device may also convey information using other features of the mobile device including, but not limited to, playing audio through the device's audio system or enabling various lights on the mobile device such as an LED camera flash. In a further embodiment, the mobile device may also be paired with a vehicular telematics system, and may convey information using features of the vehicular telematics system.

The application may display status information to the user through a graphical user interface. This status information may include, among other things, that the application is running, that the application is connected to a monitor, the identity of a child seat actively monitored by the application, the orientation of the child seat to which the monitor is attached, the belt tension of belts attaching the child seat to the vehicle, the belt tension of belts holding the child to the child seat, whether a child is in the child seat, whether the safety restraints are engaged, whether the vehicle is moving, the amount of time elapsed since a previous condition or alert of a condition was conveyed, the amount of time remaining until a condition left unaddressed produces an alert, the temperature of the vehicle interior near the child seat, or any other condition contemplated herein or otherwise known in the art.

In an embodiment, the user interface includes graphical or audible cues to quickly convey information to the user without the user having to study or examine the interface for a significant amount of time. This is particularly important where the user is operating the vehicle and it is preferable that the user does not divert attention from safe vehicle operation. For example, the application may include a color-coded indicator, such as a border around a status indicator, which indicates whether the condition is acceptable (green) or requires attention (red). Where all reported conditions are acceptable—for example, temperature near the child is within tolerances, the child seat is installed at proper orientation and with acceptable belt tension; the child is in the seat with safety restraints engaged—the color indicator is green. If any condition is not acceptable, the color indicator is red. In an embodiment, the color may be coded to a particular condition. By way of example and not limitation, the status border may be yellow where a child is in the child seat and the safety restraint belts are not clasped, but the vehicle is not in motion. However, the status border may change to orange if the same condition persists while the vehicle is in motion. Similarly, the status may be orange or red if the child vacates the child seat with the vehicle in motion. Where the application has lost its connection to the child seat monitoring system, the border may change to red or another distinctive color to alert the user that the connection has been lost and the information displayed may not be current. The user may thus glance only momentarily at the application and quickly assess whether any condition exists which the user should address.

The particular color scheme to be used will depend on the severity of the conditions, and generally the more severe conditions are assigned colors psychologically associated by most users with increasing levels of risk or danger, with cool tones such as green and blue indicating safe conditions, and warm tones such as red and orange indicating dangerous or risky conditions. The color coding may also vary within a given condition depending on the severity of the condition. For example, the color indicator may be orange if the temperature near the child seat drops below 60 degrees, and may turn red if it drops below 40 degrees, quickly conveying to the user not only that a temperature condition exists, but the approximate severity of the condition. In an embodiment, the thresholds for these color indicators may be set by the user, or may be automatically adjusted depending on other conditions. By way of example and not limitation, the user may configure the application to provide a basic alert (orange) if the temperature is below 65 degrees or above 80 degrees, and to provide an urgent alert (red) if the temperature is below 50 degrees or above 90 degrees. In an embodiment, the user may define more than two alert levels, or use only one alert level.

Audible indicators may be sounded using the mobile device's speaker system. This has the advantage that the user need not consult the device screen at all, but may assume all conditions are acceptable, unless the device indicates otherwise. In a still further embodiment, the device's vibrate feature is activated to indicate a problem.

When a condition occurs which may merit the user's attention, an alert may be displayed in the application providing the user the opportunity to address the condition, such as by touching a button element in the user interface thereby indicating that the user wishes to disregard or “snooze” the warning. For example, the user may be presented with the choice of ignoring the alert, such as where the user is aware of the condition and the condition is not a concern. This may happen, for example, where cargo is placed in the child seat and the monitor reports the weight of the cargo as a child, and alerts the user that the safety restraint harness is not clasped. In an embodiment, the button element in the user interface indicates the reason the alert was triggered.

The application may also display the elapsed time, or duration, of the condition detected. By way of example and not limitation, where the child vacates the child seat while the vehicle is in motion, a timer may be displayed in a status indicator in the application showing the time when the condition was first detected, and/or the duration that the condition has persisted.

The application is generally able to run as a background monitoring service on the device, and need not be the foreground application for the device in order for the application to receive and report information, notifications, and alerts concerning the status of the child and/or the child seat. In an embodiment, the application provides an interface through which the user can manually start or halt the background monitoring service.

By way of example and not limitation, the application may display an icon in the form of an exclamation point, or other image signifying an emergency condition, superposed upon an image of a child seat at the approximate location where the condition is detected. By way of example and not limitation, where the condition is improper belt tension, an exclamation point is displayed near the belt in the image.

Also by way of example and not limitation, the temperature of the child, or of the air near the child, may be monitored by a temperature sensor and the observed temperature displayed to the user via the application. This is particularly helpful with common family vehicles such as mini-vans, where the air through put for rear ventilation systems is not the same as cabin-forward systems, and children are generally safest in the middle and back rows of mini-vans. Thus, the driver may be comfortable even though the children are not, and young children in particular lack the ability or inclination to detect temperature discomfort and so inform the driver.

Also by way of example and not limitation, conditions detected, including, but not limited to, belt tension and seat orientation, including pitch, roll, and slip, may be wirelessly transmitted to and displayed on a mobile device. The orientation angle with respect to vehicle may be displayed, or the amount of variance from the preferred range may be displayed, along with, optionally, notifications or alerts indicating an improper orientation or belt tension. Similarly, if the vehicle is in motion and belt tension loosens or a sensor detects that a child has vacated a seat, an immediate notification may be provided to the user so that appropriate action may be taken (e.g., the car is stopped and the child reseated).

The precise design of an application and the manner in which notification data is conveyed to the user will necessarily vary with platform, changing aesthetic tastes and interface design principles, and other considerations such as safety standards. By way of example and not limitation, the display in the application may be disabled, or not updated, while the vehicle is in motion, and notifications may be provided only audibly.

The systems and methods may also use the notification system to provide diagnostic information, including but not limited to, whether a mobile device is connected with the monitor, how much time has passed since a mobile device last received a notification from the monitor, estimated remaining battery life, the monitor's serial number or model number, enabled or supported features or functions, manufacture date, firmware or other software version, warnings, and errors.

In an embodiment, the application is customizable and provides a user interface for inputting user preferences and customizing notifications, alerts, and other application settings. Among other things, the user can change, customize, or configure: colors; custom images displayed; custom alert tones sounded; font size and face; notification settings, including, but not limited to, alert intervals, snooze time, vibration and audible alert settings; temperature thresholds; condition duration thresholds, including, but not limited to, how long a child may be left in a child seat with the vehicle stationary before the user is notified; and other customizable features as described herein or known in the art.

In an embodiment, the system may be configured or configurable to report or not report one or more of conditions detected by the sensors. For example, where the systems and methods include a light sensor, the system may be configured not to report light conditions. Again, this configuration is generally inputted by the user using a user interface in an application on a mobile device.

There are a number of ways this configuration may be implemented. In one embodiment, the user has configured the system to ignore, disregard, or otherwise not use or report a particular condition and this user configuration is communicated to the monitor by the mobile device. In such an embodiment, the microprocessor in the monitor may disable or otherwise turn off a sensor which detects that condition. This has the advantage that the microprocessor need not store or cache configuration options, simplifying the physical and logical architecture, and reducing the amount of memory components, if any, needed.

In an alternative embodiment, the microprocessor may not disable or turn off a sensor, but may instead simply disregard data from sensors which the microprocessor is configured to ignore. This has the advantage of allowing the microprocessor to monitor sensor health and detect when a sensor is not functioning properly because the sensor is still transmitting data and, if the sensor stops transmitting data, the microprocessor may determine or indicate that condition as a possible error or failure. However, this also generally means the microprocessor must have access to a local memory to store configuration options. However, in an embodiment the microprocessor does not store configuration options in a local memory but instead uses an external memory, or communicates with the mobile device to get user configuration settings in real-time or near-real-time.

In another embodiment, user configuration options are implemented at the “client side,” such as on in mobile device application. In such an embodiment, no configuration information need be transmitted or communicated to the monitor microprocessor for implementation. Rather, the microprocessor will report and communicate all condition data received by the microprocessor from the sensing and monitoring systems, and the mobile device will filter this information depending upon the configuration options selected by the user. By way of example and not limitation, where the user has indicated that the user does not wish to receive any notifications concerning a particular condition, these conditions continue to be detected by the sensing system and transmitted to the mobile device by the transmitting system. However, the receiving system is generally included in the mobile device, and the mobile device application can filter which notifications are conveyed to the user.

For example, the device may receive condition data from the monitor indicated that the air temperature is too warm near the child seat, but if the user has configured the application not to report temperature alerts, the application will disregard this alert and not convey it to the user (though the application may still continue to display the current temperature to the user). This has the advantage of simplifying the physical and logical architecture of the monitoring devices, and reducing configuration data synchronization problems between the mobile device and the monitor.

Configuration options are not limited to whether a condition is reported. In an embodiment, a user may configure the systems and methods to report a condition only when the condition reaches a certain threshold. This threshold may be pre-configured, such as by a default setting in the reporting application, or may be manually selected by the user. By way of example and not limitation, a user may configure the system not to provide notifications concerning temperature unless the internal vehicle temperature is below a certain level or above a certain temperature.

Notifications may also be filtered based upon other configuration options. By way of example and not limitation, the user may configure the systems and methods to provide notifications concerning whether a safety belt is unclasped only when the vehicle is in motion. Also by way of example and not limitation, the user may configure the systems and methods to provide notifications concerning whether a safety belt is unclasped only when the vehicle is not in park. This allows the user to reduce the amount of notifications the user receives of harmless or anticipated conditions, such as unclasped belts when the systems and methods are operational but children are being loaded into or unloaded from the vehicle. Notifications may also be filtered based on the duration of the condition, or the duration of the condition being above a certain threshold. By way of example and not limitation, a user may configure the system to provide notification that the internal vehicle temperature is above a defined threshold only if the temperature remains above that threshold for at least a certain period of time as defined by the user.

For example, the user may configure the system to provide a temperature notification only if the temperature exceeds 75 degrees for more than five minutes. This also assists the user in reducing the amount of harmless notifications received. For example, on a very hot day where the user has been at a shopping mall with children all morning, the internal temperature of the vehicle will be very high when the user returns to the vehicle with children. However, once the vehicle is started and its environmental controls are activated, the temperature will moderate. Absent this configuration option, the systems and methods may detect the unusually high temperature and provide notifications to the user, although the user may not want or need those particular notifications because the user is aware the vehicle is too hot, or the condition is only temporary. By configuring the system not to provide temperature alerts unless the temperature persists above threshold for at least five minutes, the user may avoid receiving some or all of these unwanted notifications, because the vehicle's internal temperature will moderate quickly once the user enables the internal environmental controls.

A user may have different configuration settings in an application for different child seat monitors paired with the mobile device.

In particular, the application allows the user to establish a notification or alert hierarchy though which the user indicates to the application who shall be notified, and through what means, and in what order or priority. By way of example and not limitation, the user may provide, among other things a mobile telephone number to which messages such as SMS text messages are sent containing notifications or alerts, including a customized message for that particular child seat whose monitor generates the alert. The user may also or alternatively provide an email address or other contact information. By way of example and not limitation, when a child is left in the child seat for an amount of time in excess of the threshold set by the user (or set by default) in the application, the notification hierarchy determines what efforts are made by the systems and methods to provide notifications.

In addition to the mobile device itself providing a notification through the application, the device may, if so configured, send a custom text message to the provided number. Additional information may also be added to the message by the application, including without limitation: the child seat identifier; time, date, and/or duration of the condition; GPS coordinates of the vehicle; temperature in the vehicle; and other information, data, or condition detected or detectable as described herein. This is especially important where the mobile phone is left in the vehicle or its sound is disabled, inhibiting the user from receiving the notifications. When this happens, the application can notify another caregiver or call or text another number, such as an office or home phone number, or a spouse or sibling or babysitter, to provide notification that the child is still in the child seat. In a further embodiment, alerts may also be emailed to one or more email addresses configured by the user. The order and timing of such alerts may also be customizable in an embodiment based on certain conditions including, but not limited to, the time of day and day of week, and these notifications may differ from child seat to child seat. The interval between notification attempts may be customized as well.

By way of example and not limitation, if the system continues to detect a child left in a child seat for two minutes, the user's phone may be alerted. If the condition persists for another two minutes, an alert may be sent via text message to the user and his/her spouse. If the condition persists for another two minutes, an e-mail message may be sent to the user and/or his spouse. If the condition persists for another two minutes, a group SMS text and e-mail may be sent to an e-distribution mail list including the user, his/her spouse, as well as family, friends, and/or coworkers. If the condition persists for another two minutes, an emergency call center or first responder may be contacted. In an embodiment, the user has the option to cancel, snooze, ignore, or otherwise disregard such messages, which cancels further notification attempts in order to prevent false alarms from cascading into a false emergency through the automated notification systems.

In an embodiment, the notification system includes a vehicle telematics system integrated in or added to a vehicle. The specific mechanism for displaying notifications will necessarily vary from system to system, depending on the output capabilities of the system, user settings, standards for safe use of a computer system while in a vehicle, whether the vehicle is in motion when the notifications are conveyed, and other such considerations. By way of example and not limitation, notifications may be provided via: a dashboard light or other indicator; a warning light; an LCD or other display screen; a touchscreen display; a heads-up display system; an audible notification via the vehicle's audio system, such as by overriding the audio system controls to provide a notification.

The systems and methods may have a “driving” mode where component systems for detecting and transmitting data related to conditions are in active communication with a nearby notification system (such as a mobile phone or integrated vehicular telematics system) conveying such notifications to a user. This mode is generally contemplated to apply where a user is in or immediately near the vehicle containing the child seat, such as where the user is installing a car seat, loading or unloading children, or operating the vehicle.

The systems and methods may also have an “emergency” mode, which is generally contemplated to apply where the user is not in or immediately near the vehicle, but a child has been left in a child seat. In this mode, the condition detecting and transmitting systems may or may not be in active communication with a notification system and will attempt to notify the user or other caregivers of the child's predicament, possibly culminating in an attempt to notify emergency personnel.

By way of example and not limitation, where a child is left in the child seat having device (1011) and the user has left the vehicle, a sensor may detect the presence of the child (1003) and note that the vehicle has been stationery for several minutes. If the transmitter is paired with the user's mobile device, the transmitter may transmit to the mobile device data relating to this condition. The mobile device application receiving this data then conveys to the user, such as via a display or audio alert, that a child is detected as still being in the car, which is no longer moving. The application may present an acknowledgement interface requiring the user to acknowledge or ignore the condition. For example, the user may have parked the vehicle in his own driveway temporarily while he goes indoors to retrieve a forgotten item, and the child being left in the car is not deemed by the user to be a dangerous condition.

However, if this notification is not acknowledged by the user through the application interface, the application logic may continue to repeat the notifications so long as the device (1011) continues to report (1017) that the condition (1003) of a child left in the seat persists and the mobile device is paired with the transmitter. If no acknowledgment is received, and the condition (1003) is not remedied, the application may commence a series of cascading escalations of the notification to other persons and/or through other means, according to a notification hierarchy (1027) configured by the user. Among other things, this may include that the application causes the mobile device (1041) to place calls, send text messages, send emails, or otherwise attempt to communicate with persons and via communications channels configured in the notification hierarchy (1027) for the particular mobile device (1011) and for the particular child seat in the particular vehicle.

If so configured, the mobile device may attempt to contact emergency personnel, including, but not limited to, law enforcement, a fire department, emergency medical personnel, or other first responder. The mobile device may attempt to contact or notify an emergency call center of the condition, and personnel at the call center then attempt to contact the user or other caregivers according to a notification hierarchy or other contact information provided by the user, similar to a home security system monitoring service.

It may happen that the pairing between the monitor and mobile device is lost or interrupted without a resolution nor acknowledgement of an urgent condition alert. For example, the user may walk out of range the transmitter's transmission range, or the mobile device's battery may die. In one embodiment of the monitor, the monitor itself has hardware components which may be used to attempt the communications and notifications described herein, including, but not limited to, sending text messages, placing telephone calls, sending e-mails, contacting emergency response personnel, or notifying a call center of the situation, either according to a notification hierarchy (1027), or according to a simpler set of preconfigured rules.

It is also contemplated that the monitor (1011) may be integrated into, or otherwise in communication with, automated or automatable systems and operations of the vehicle such that an emergency situation or condition may be fully or partially mitigated by operating or causing to be operated systems and operations of the vehicle. This may be done, for example, where a monitor may manipulate certain vehicular systems and operations, such as through a vehicular telematics system, or where the device alerts service personnel with the ability to remotely operate the vehicle's systems, such as On-Star®.

In such an embodiment, vehicular systems, features, controls, and operations may be operated, enabled, or disabled, including without limitation: environmental controls; windows; temperature; fan; ventilation; radio; heaters, including seat heaters; on-board entertainment systems; engine start or stop; automated vehicular locomotion, including, but not limited to, self-driving, self-piloting, or remote-driving systems; locks and releases, including, but not limited to, windows, doors, hood, trunk, sun roof, moon roof, gas tank, and other access points to the vehicle; horn; internal or external lights; vehicular communications systems, including, but not limited to, telephone, Internet, wireless, global positioning, on-board systems, or other communications systems; safety restraint and airbag deployment systems, including, without limitation, belt tension and airbag velocity; cigarette lighters; power supplies and audio-visual connectors; entertainment systems, including, without limitation, radio and media players; locomotive controls including, without limitation, acceleration, braking, and steering. It is specifically contemplated that the systems and methods may interoperate with driverless vehicle systems including, but not limited to, the Google driverless car.

This monitor may detect or receive information regarding external conditions and operate the vehicle's systems accordingly to safeguard the health and safety of a child left in the car. By way of example and not limitation, where an infant is left in the vehicle during the winter season and the temperature sensor detects that the interior temperature of the vehicle is too cold for an infant, the system may cause the vehicle's internal environmental controls to operate to produce warm air to increase the temperature to within tolerable levels for an infant. This may require that other systems are operated as well. For example, where heat is needed, vehicles typically pull heat from the engine and the system may cause the engine to start, the internal airflow fans to operate, and the vehicle's heater to direct heat into the cabin. If the temperature reaches an opposing threshold (e.g., the temperature is dangerously high) the system may then cause the vehicle to moderate temperature. By way of example and not limitation, the system may cause the vehicle to maintain a consistent temperature of 70 degrees, or another suitable temperature under the circumstances.

In an embodiment, the system may monitor or be provided with information concerning external conditions and operate the vehicle's systems accordingly. For example, in an embodiment, the monitor may have access to a weather database, such as through a vehicle telematics system. The monitor may also be able to acquire the vehicle's GPS coordinates from the vehicle telematics system. In such an embodiment, the monitor may query the weather database for weather conditions near the GPS coordinates of the vehicle. If the indication is that precipitation or low visibility is anticipated, the response system may instruct the vehicle to raise windows to prevent precipitation from entering the vehicle, and/or turn on exterior lights so that the vehicle may be more easily seen, reducing the chances of the vehicle being struck or overlooked by rescuers. Also by way of example and not limitation, the systems and methods may determine that the external temperature is low and attempt to start the engine at certain intervals to reduce the chances that the engine becomes frozen or otherwise unable to be started.

In an embodiment, the response system may monitor or be provided with information concerning the available resources of the vehicle and operate the vehicle's systems accordingly. By way of example and not limitation, the systems and methods may detect that the vehicle battery is low on power. This may occur, for example, where the battery has been used by the systems and methods to operate or power the vehicle's systems as elsewhere described herein. The response system may then start the vehicle's engine to operate the alternator and recharge the battery, and shut off the engine once the battery is charged beyond a certain threshold to preserve fuel.

In an embodiment, the system may monitor or be provided with information concerning the limits of its own resources and operate the vehicle's systems accordingly. By way of example and not limitation, in an embodiment the systems and methods include devices powered by batteries. If the remaining charge of such batteries drops below a particular threshold, the systems and methods may operate the vehicle in a manner designed to prolong the safety of a child left within the vehicle for as long as possible under the circumstances after the batteries die and the systems can no longer control the vehicle. For example, if the external conditions are a hot, sunny day, the systems and methods may raise the windows, turn the vehicle on, and turn the air conditioning on to keep the child comfortable even if the batteries in the device expire.

Also by way of example and not limitation, under such circumstances the systems and methods may determine that the vehicle's fuel supply is too low to run the air conditioner for a sufficient period of time for rescue. In such circumstances, the systems and methods may fully or partially lower the vehicle's windows so that when the fuel runs out and the vehicle's systems can no longer be operated, the windows are down and the child is not enclosed in a vehicle left out in the sun. If the child becomes uncomfortable and begins to cry, the lowered windows also increase the likelihood that a nearby rescuer will detect the dangerous situation and intervene.

The systems and methods can cause the vehicle to adjust the performance of safety systems in response to the presence of a child in a child seat. By way of example and not limitation, the systems and methods may cause the vehicle to alter the automatic tensioning of safety restraint harnesses or belts in the event of an accident when a child seat is secured to the vehicle using that safety restraint harness. Similarly, the systems and methods may cause the vehicle to disengage or alter the performance of airbag deployment systems in seating positions in which a child seat is present, or disable the cigarette lighter when a child is present in a child seat.

Information related to automated actions taken is transmitted to the receiving system and may be conveyed to the user like other notifications or alerts. In a further embodiment, such information is transmitted in consultation with or according to an alert hierarchy as described elsewhere herein. By way of example and not limitation, where the vehicle is started and the temperature controls operated, information may be transmitted indicating that the vehicle's engine was successfully started and when, that the heater was engaged and when, that internal fans were engaged and when. Information may also be provided related to any accompanying change in temperature or other change in status.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A system for providing notifications of a condition relating to a child in vehicular child seat, the system comprising:
a sensor installable in a vehicular child seat and capable of detecting a condition relating to a child in said vehicular child seat when said sensor is installed in said vehicular child seat;
a transmitter connected to said sensor by circuitry; and
computer-readable instructions on a non-transitory memory comprising programming which, when said non-transitory memory is in a device capable of receiving data from said transmitter, causes said mobile device to transform into a notification data received by said mobile device from said transmitter relating to a condition detected by said sensor when said sensor is installed in a vehicular child seat.

2. The system of claim 1, wherein said sensor is a three-axis accelerometer and said condition is the orientation of said vehicular child seat installed in a vehicle.

3. The system of claim 1, wherein said sensor is a force transducer and said condition is the tension on a safety restraint belt.

4. The system of claim 1, wherein said sensor is a temperature sensor and said condition is the air temperature near a child in said vehicular child seat.

5. The system of claim 1, wherein said notification is a graphical element caused to be displayed by said device.

6. The system of claim 1, wherein said notification is an audible tone caused to be emitted by said device.

7. The system of claim 1, wherein said notification is a message transmitted by said device to another device.

8. The system of claim 7, wherein said message is a user-defined text message sent to a user-defined mobile telephone number.

9. The system of claim 7, wherein said message is a user-defined e-mail message sent to a user-defined e-mail address.

10. The system of claim 9, wherein said e-mail address is a distribution list.

11. The system of claim 7, wherein said message is a call.

12. The system of claim 7, wherein said message is sent to an emergency response call center.

13. The system of claim 7, wherein said message is transmitted only after a condition first detected by said sensor is again detected by said sensor after a user-defined amount of time elapses from said first detection.

14. The system of claim 1, wherein said device is a mobile device.

15. The system of claim 14, wherein said notification is the vibration of said mobile device.

16. The system of claim 14, wherein said mobile device is a mobile phone.

17. The system of claim 16, wherein said mobile phone is selected from the group consisting of an iPhone, a Windows Phone, a Galaxy phone, a Google phone, an Android phone.

18. The system of claim 14, wherein said mobile device is a tablet computer.

19. The system of claim 1, wherein said device is a vehicular telematics system.

20. The system of claim 1, wherein said transmitter communicates using the Bluetooth protocol.
